(19) United States
(12) Patent Application Publication
(10) Pub. No.: US 2012/0117856 A1
(43) Pub. Date: May 17, 2012

(54) Pest Control System

(76) Inventors: Nicholas Cefalu, Quincy, MA (US); Linda Patricia O'Brien, Quincy, MA (US)

(21) Appl. No.: 13/289,727

(22) Filed: Nov. 4, 2011

Related U.S. Application Data
(60) Provisional application No. 61/410,182, filed on Nov. 4, 2010.

(51) Int. Cl. A01M 1/20; B23P 11/00

(52) U.S. Cl. 43/131; 29/428

(57) ABSTRACT

A system for controlling pests such as bed bugs includes a channel configured to substantially surround a protected area. The channel includes an interior surface and an exterior surface. Powder is disposed on the interior surface, and a seal is disposed on the exterior surface. Seal 20 is configured to prevent bed bugs from traveling between the exterior surface and a third surface on which the system is to be installed, such as a floor. Bed bugs can not pass through the channel, since bed bugs would have to crawl up the exterior surface and into the interior surface, becoming stuck in the powder.

### RELATED APPLICATIONS

This application claims priority to U.S. Patent Application Ser. No. 61/410,182, entitled The Bedbug Gutter, filed on Nov. 4, 2010.

### BACKGROUND

1. Technical Field

This invention relates to pest control tools, and more particularly to bed bug pest control tools.

2. Background Information

Throughout this application, various publications, patents and published patent applications are referred to by an identifying citation. The disclosures of the publications, patents and published patent applications referenced in this application are hereby incorporated by reference into the present disclosure.

Cimicidae, or bed bugs, have become an increasingly serious problem, especially in urban areas. Bed bugs have been found in department stores, office buildings, movie theaters, and hotels. A recent article in the New York Times discussed the recurrence of the bed bug problem. “A survey last year by the New York City health department found that 6.7 percent of adult New Yorkers—some 400,000 people—reported a problem with bedbugs that required an exterminator in the previous 12 months.” (New York Times Sep. 4, 2010). Bed bugs were once controlled with DDT, and have since become DDT resistant. Proposals have been made to allow the use of other chemicals, including highly toxic chemicals.

Some pest controllers are placing their hopes on resuscitating propoxur, a highly toxic chemical that was phased out of indoor uses because it could cause nervous-system damage in children. Ohio and Kentucky have asked the Environmental Protection Agency to allow professional exterminators to use it indoors, and other states may follow suit. The requests are based in part on laboratory tests by a Kentucky entomologist on small groups of bedbugs. Some of today's leading pesticides could not kill even half of the bugs, while propoxur wiped them all out in two hours. The E.P.A. is studying whether there might be limited situations—a nursing home with no children present—where it could be used.

(New York Times Sep. 4, 2010). The use of toxic chemicals is clearly problematic, especially for use in residences with children.

Another problem is that bed bugs often live in walls of buildings and emerge to feed on a host. For example, in residences, bed bugs travel from the walls in order to feed on sleeping humans, then return to the wall. When bed bugs live in the walls, it is very difficult for pest control professionals to access and eliminate the bed bugs. Bed bugs may live in the walls of a building for up to 18 months without feeding. Even after pesticide application, bed bugs in the walls may return to bedrooms to feed on hosts. A single application of pesticide therefore does not eliminate the bed bugs. Repeated pesticide applications add to the cost and toxicity of these treatments.

In addition, a resident may introduce a new set of bed bugs by bringing an infected item into a residence such as an apartment building. This new set of bed bugs will likely spread quickly to other apartments.

Currently available techniques for controlling bed bugs have drawbacks. As discussed above, repeated application of toxic pesticides are problematic. Some devices are designed to fit under a bed leg, to prevent bed bugs from crawling up a bed leg into the bed. These devices have several drawbacks. They do not protect a room or apartment from infestation. Other items in the room outside of the bed, such as clothes, shoes, and furniture, are not protected. They do not even protect a bed from infestation. Even if the devices are placed under all four bed legs, bed bugs may still travel up to the bed from the floor via any overhanging object, such as a blanket hanging to the floor. These devices could easily crack under the weight of a bed leg. Since bed bugs are very small, any crack in the device would allow the bed bugs to travel through the device. Another problem is that bed bugs in a bed may live in a wooden bed leg, emerging at night to feed on a human host, without ever having to leave the bed. Significantly, these devices do not prevent the spread of a bed bug infestation from one room or apartment, to the rest of a building.

Therefore, a need exists for a non-toxic system and method of controlling bed bugs, and preventing infestations from spreading throughout a building.

### SUMMARY

In one aspect of the invention, a pest control system includes a channel with an interior surface and an exterior surface, with powder disposed on the interior surface. A seal disposed on the exterior surface is configured to prevent pests from passing between the exterior surface and a third surface, such as a floor. The system is configured for installation on this third surface.

In another aspect of the invention, a process for controlling pests includes fitting a channel around a protected area. The channel includes an interior surface and an exterior surface, with powder disposed on the interior surface. This aspect also includes sealing the channel to a third surface on which the channel is to be installed.

In another aspect of the invention, a process for manufacturing a pest control device includes forming a channel with an interior surface and an exterior surface, disposing powder on the interior surface, disposing a seal on the exterior surface, and configuring the seal to prevent pests from passing between the exterior surface and a third surface on which the channel is to installed.

### BRIEF DESCRIPTION OF THE DRAWINGS

The above and other features and advantages of this invention will be more readily apparent from a reading of the following detailed description of various aspects on the invention taken in conjunction with the accompanying drawings, in which:

FIG. 1 is a top plan view of an embodiment of the invention;

FIG. 2 is a cross sectional view of the embodiment of FIG. 1;

FIG. 3 is a top plan view of an embodiment of the invention;

FIG. 4 is a perspective view of a portion of an embodiment of the invention;

FIG. 5 is a perspective view of a portion of an embodiment of the invention;

FIG. 6 is a schematic top plan view of an embodiment of the invention;

FIG. 7A is a perspective view of a portion of an embodiment of the invention;

FIG. 7B is a perspective view of a portion of an embodiment of the invention;

FIG. 8 is a perspective view of a portion of an embodiment of the invention;

FIG. 9 is a perspective view of a portion of an embodiment of the invention;

FIG. 10 is a top plan view of a portion of an embodiment of the invention;

FIG. 11 is a bottom plan perspective view of a portion of an embodiment of the invention;

FIG. 12 is a side plan view of an embodiment of the invention;

FIG. 13 is a top perspective view of an embodiment of the invention;

FIG. 14 is a bottom perspective view of an embodiment of the invention;

FIG. 15 is a flow chart of a process associated with an embodiment of the invention; and

FIG. 16 is a flow chart of a process associated with an embodiment of the invention.

### DESCRIPTION

In the following detailed description, reference is made to the accompanying drawings that form a part hereof; and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and the scope of the present invention. The following detailed description, therefore, is not to be taken in a limiting sense, and the scope of the present invention is defined by the appended claims and their equivalents. For clarity of exposition, like features shown in the accompanying drawings shall be indicated with like reference numerals and similar features as shown in alternate embodiments in the drawings shall be indicated with similar reference numerals.

Embodiments of this invention provide a low-cost, non-toxic system for the control of pests such as bed bugs. These embodiments prevent the spread of an infestation from one room to the rest of a building. These embodiments also protect a room from infestation from bed bugs living in the walls of a building.

In one embodiment, the system is set up around a room, for example, adjacent to a baseboard of a room. By surrounding or partially surrounding a room, the system prevents bed bugs from entering the room. In the event that a person introduces an infestation into the room, for example, by bringing in infested furniture, then the system encircling the room prevents the infestation from spreading through walls to other rooms. Therefore, these embodiments provide a low-cost maintenance system for preventing a single infestation from spreading throughout an entire building.

Bed bugs are unable to pass through the system. For example, bed bugs living in the walls of a residence will typically emerge at night to feed on a host such as a sleeping human. Bed bugs will crawl out of the wall and along the floor to a bed leg or hanging bed linens. The bed bugs will then crawl up the bed leg or bed linens to feed on the host. The bed bugs will then crawl down the bed leg or bed linen, along the floor, and back in to the walls.

Embodiments of this system include channels configured to surround and protect a room. In such embodiments, the system is set up on the floor of a room, and sealed to the floor. Bed bugs exiting the walls will crawl up the exterior surface of the channel into the interior surface of the channel. The bed bugs then become trapped in powder disposed on the interior surface of the channel. The bed bugs are unable to travel to the bed in order to feed on the host. The powder also clogs the bed bugs' external respiratory systems, thereby killing the bed bugs.

These embodiments also have a prophylactic use in preventing infestations from spreading. For example, an owner of an apartment building could implement embodiments of the invention in each room to protect other rooms from infestation. If a tenant brings in an infested item such as a piece of furniture, then the bed bugs in that furniture would be contained in that apartment. Bed bugs attempting to exit an apartment room via the walls would crawl along the floor, up the exterior surface of a channel embodiment, down into the interior surface, and become trapped in the powder.

The embodiments would have a prophylactic use, providing an ongoing protection from infestation, thereby providing a permanent solution to a recurring problem of repeat infestations. The system therefore provides low-cost, non-toxic control and prevention of bed bug infestations.

For the purposes of this discussion, some embodiments of the system will be referred to as installed on a floor in a room interior. The system may be installed on other surfaces, such as a ceiling, as discussed below.

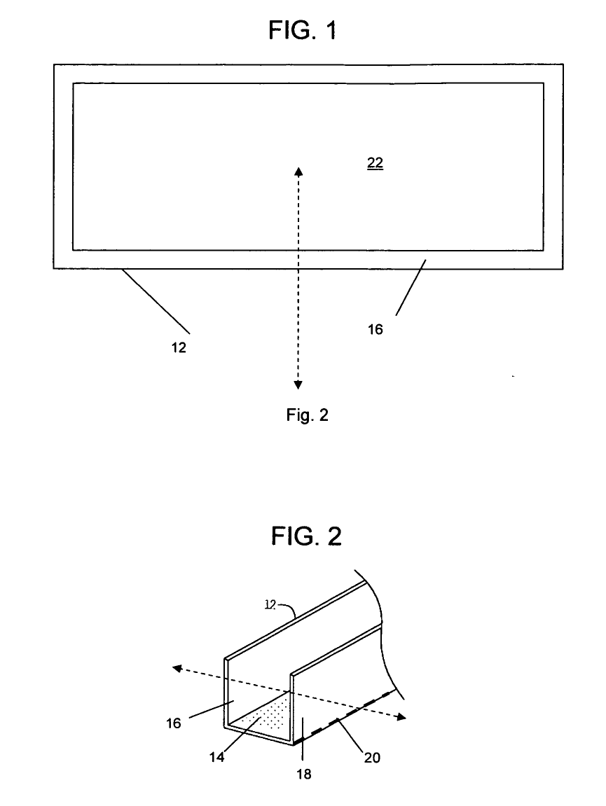

In the embodiment of FIGS. 1 and 2, the channel 12 is disposed on a floor of a room, and encircles the protected room interior 22. Channel 12 includes interior surface 16 with powder 14, and exterior surface 18. Seal 20 on exterior surface 18 prevents pests from passing between exterior surface 18 and the floor. In this embodiment, channel 12 is u-shaped. In other embodiments, channel 12 may be in various shapes, including concave or even planar.

In some embodiments, channel 12 is a continuous flexible channel. For example, channel 12 may be a bendable contiguous loop, or a bendable channel which may be fastened at each end to form a contiguous loop. In other embodiments, channel 12 includes pieces which may be connected to form a continuous channel. Various attachment mechanisms may be used. For example, the channel pieces of some embodiments are configured to be attached by friction fit; and the channel pieces of some embodiments are configured for attachment by adhesive.

In some embodiments, seal 20 is an adhesive such as double sided tape or glue. Seal 20 may comprise substantially any material which prevents bed bugs from passing between the exterior surface 18 and the surface on which the system is installed (e.g., a floor). For example, in some embodiments, the seal comprises hardware, such as a screw that fastens the system to a carpeted floor or other surface.

Embodiments of powder 14 comprise talcum powder. In other embodiments, powder 14 may be substantially any substance which the bed bugs would get caught, such as diatomaceous earth. Optionally, the system may include replacement powder configured for disposal on the interior surface by a user.

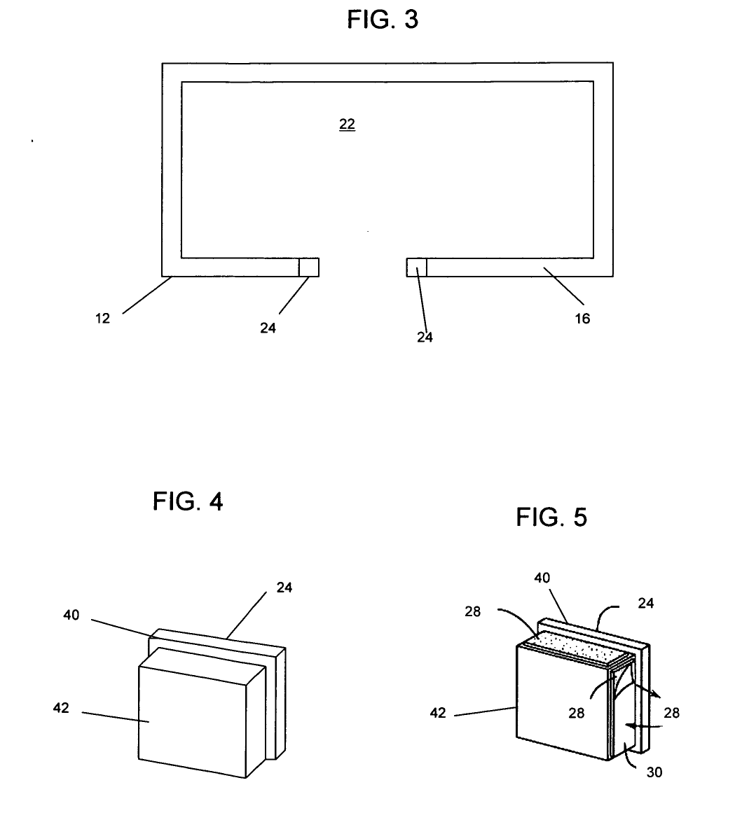

In some embodiments, channel 12 may substantially surround a protected area, but allow gaps, for example, for door openings. In such embodiments, channel 12 is capped at each end before the gap. For example, in the embodiment of FIG. 3, channel 12 is capped with channel pieces endcaps 24. Endcaps 24 prevent bed bugs from escaping from interior surface 16.

Examples of endcaps 24 are shown in FIGS. 4 and 5. In the embodiment of FIG. 4, endcap 24 includes a lip 40 and an insertion section 42 which is configured to be inserted into the channel 12. Upon insertion into a channel, lip 40 would remain exterior to the channel. The endcap 24 of the embodiment of FIG. 5 includes adhesive 30, which is configured to adhere to the interior of channel 12. Protective paper 30 is configured to protect the adhesive 28 until removed by the user in order to adhere the endcap 24 to channel 12. Other endcap embodiments allow the endcap to attach to the exterior of the channel. Substantially any connection mechanism may be used.

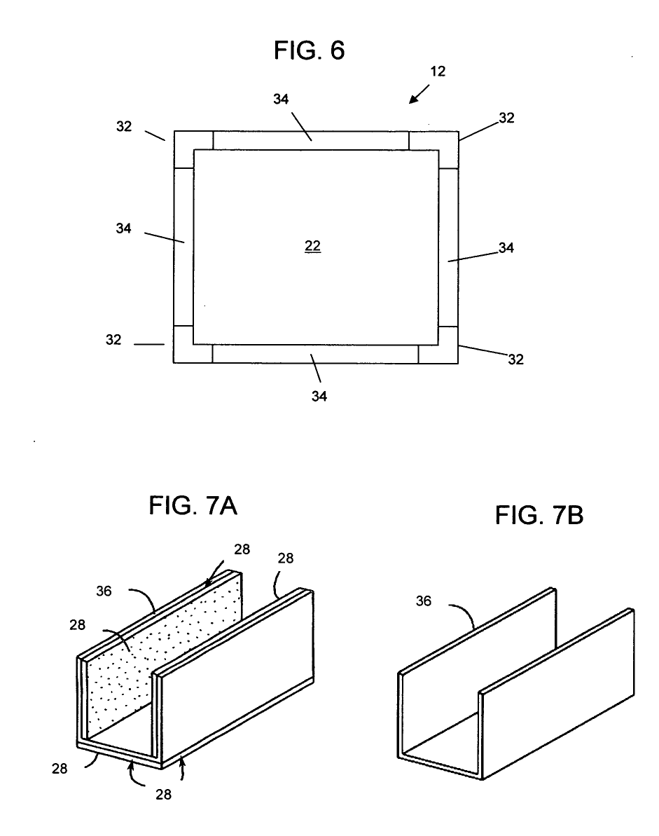

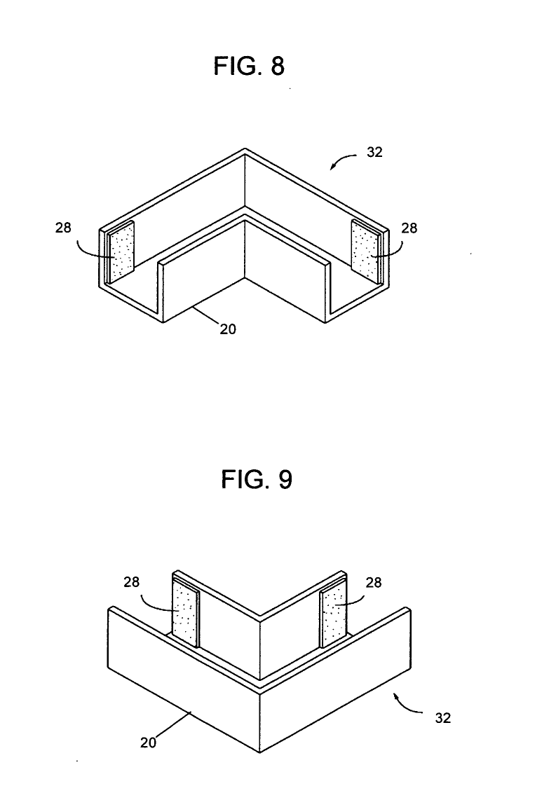

In the embodiment of FIG. 6, channel 12 includes corner pieces 32 and component pieces 34, which are fastened together so that channel 12 encircles protected area 22. In some embodiments, component pieces 34 and corner pieces 32 are configured to be attached with an adhesive. In other embodiments, components 34 and corner pieces 32 are configured to be attached by friction fit. Some embodiments include connectors configured to attach channel pieces such as corner pieces 32 and components 34. For example, connector 36 of FIG. 7A is configured to attach to outside surfaces of channel pieces. Optionally, adhesive 28 adheres connector 36 to the channel pieces. In the embodiment of FIG. 7B, connector 36 attaches to the inside surfaces of channel pieces.

Examples of corner pieces 32 are shown in FIGS. 8 and 9. In these examples, corner piece 32 includes adhesive 28 to adhere the corner pieces 32 to other channel pieces. In this embodiment, corner piece 32 includes a seal 20 which is comprised of an adhesive. In other embodiments, corner pieces are configured to attach to the outside surfaces of channel pieces.

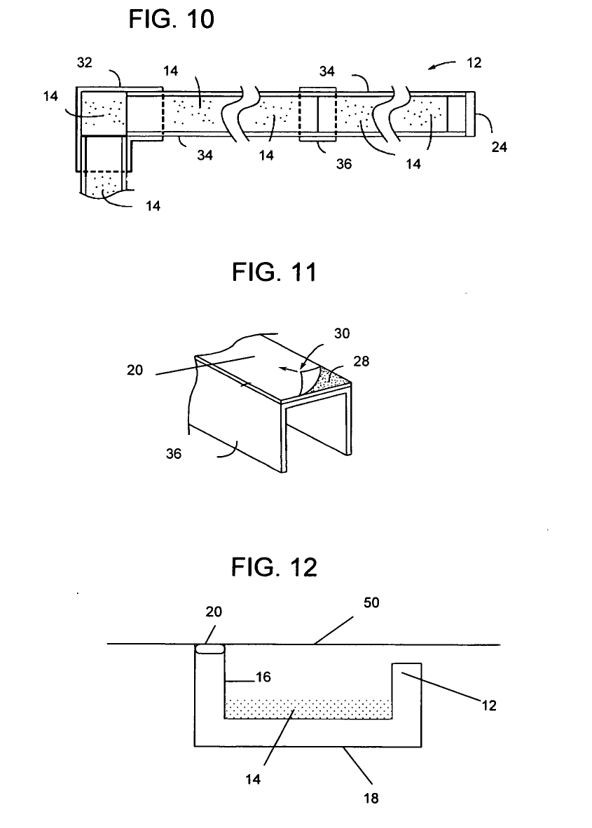

In the embodiment of FIG. 10, channel 12 includes corner piece 32, component pieces 34, and connector piece 34. This embodiment of corner piece 32 includes powder 14. In some embodiments, connectors 36 attach to the interior surfaces of channel pieces 12. In the embodiment of FIG. 11, connector 36 includes seal 20. This embodiment of seal 20 includes adhesive 28, which is protected before use by protective paper 30.

In addition, some embodiments of channel 12 include component pieces of varying sizes to allow a user to fine-tune the length of the channel 12 to fit an area. For example, an embodiment includes smaller-sized component pieces in order to fine tune the fit of channel 12 around a protected area.

In some embodiments, the channel has a transverse dimension (width) of about 0.5 inches, and a depth of about 0.75 inches. The component pieces of some embodiments have an axial dimension (length) of about five feet. Other component embodiments have axial dimensions of about 6 inches. The corner pieces of some embodiments have a transverse dimension of about ⅝inch, a depth of about ¾ inch, and axial dimensions of about 4 inches from a 90 degree angle. The connector of some embodiments has an axial dimension of about two inches.

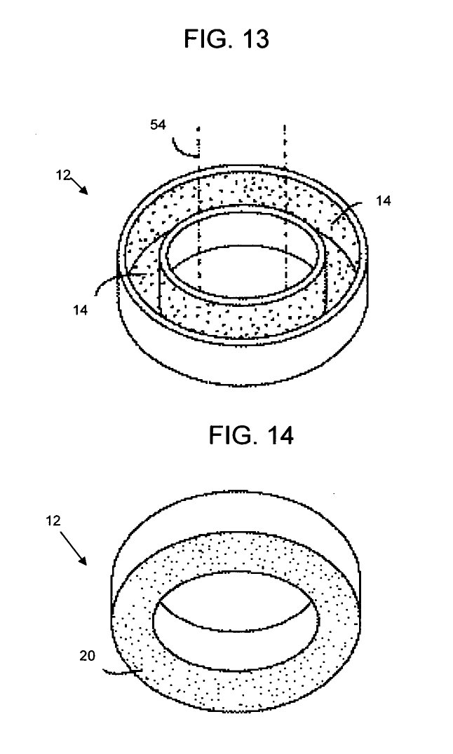

Some embodiments of this system prevent pests such as bed bugs from crawling along a ceiling or a wall. In the embodiment of FIG. 12, channel 12 is attached to ceiling 50. Seal 20 prevents bed bugs from travel between ceiling 50 and exterior surface 18. Bed bugs traveling along ceiling 50 will crawl along exterior surface 18 to interior surface 16, becoming stuck in powder 14.

In some embodiments of the invention, channel 12 is configured to form a donut shape around a protected area such as a bed leg. In the embodiment of FIGS. 13 and 14, channel 12 forms a donut shape around notional bed leg 54. Bed bugs attempting to climb from the bed leg to a floor, or from a floor to a bed leg, will be forced to crawl along internal surface 16 and become trapped in powder 14. Seal 20 prevents bed bugs from traveling between exterior surface 18 and the floor.

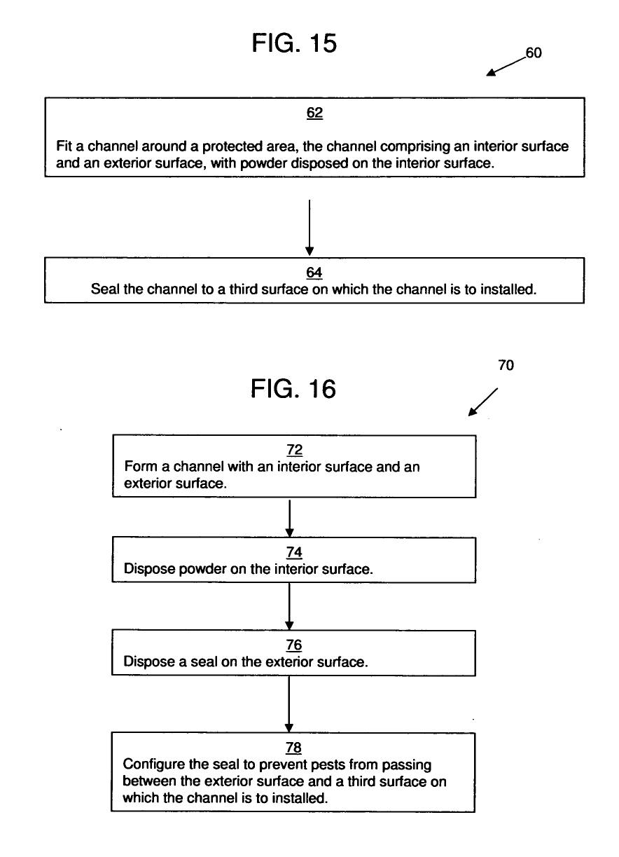

In the embodiment of FIG. 15, a process 60 for controlling pests includes Step 62, Fitting a channel around a protected area, the channel comprising an interior surface and an exterior surface, with powder disposed on the interior surface. Process 60 also includes Step 64, sealing the channel to a third surface on which the channel is to installed. In the embodiment of FIG. 16, a process 70 for manufacturing a pest control device includes Step 72, forming a channel with an interior surface and an exterior surface; Step 74, disposing powder on the interior surface; Step 76, disposing a seal on the exterior surface; and Step 78, configuring the seal to prevent pests from passing between the exterior surface and a third surface on which the channel is to installed.

It should be understood that any of the features described with respect to one of the embodiments described herein may be used with any other of the embodiments described herein without departing from the spirit and scope of the present invention.

In the preceding specification, the invention has been described with reference to specific exemplary embodiments thereof. It will be evident that various modifications and changes may be made without departing from the broader spirit and scope of the invention as set forth in the claims that follow. The specification and drawings are accordingly to be regarded in an illustrative rather than restrictive sense.

Having thus described the invention, what is claimed is:

1. A pest control system, comprising:
a channel with an interior surface and an exterior surface;
powder disposed on the interior surface; and
a seal disposed on the exterior surface, the seal being configured to prevent pests from passing between the exterior surface and a third surface;
wherein the system is configured for installation on the third surface.

2. The device of claim 1, wherein the interior surface of the channel is concave.

3. The device of claim 1, wherein the channel is configured to surround a protected area.

4. The device of claim 1, wherein the channel is configured to partially surround a protected area.

5. The device of claim 1, wherein the channel comprises pieces.

6. The device of claim 5, wherein a first piece is configured for attachment to a second piece.

7. The device of claim 6, wherein the first piece is configured for friction fit attachment to the second piece.

8. The device of claim 6, wherein the first piece is configured for adhesion to the second piece.

9. The device of claim 5, wherein the pieces include a corner piece.

10. The device of claim 5, wherein the pieces include a component piece.

11. The device of claim 5, wherein the pieces include a connector.

12. The device of claim 5, wherein the pieces include an end cap.

13. The device of claim 5, wherein a piece is of adjustable length.

14. The device of claim 1, wherein the channel is configured to be cut to fit an area.

15. The device of claim 1, wherein the powder is selected from the group consisting of fluids, talcum powder, diatomaceous earth, and combinations thereof.

16. The device of claim 1, comprising replacement powder.

17. The device of claim 1, wherein the seal is selected from the group consisting of adhesives, double-sided tape, wax, screws, clamps, magnetic forces, and combinations thereof.

18. The device of claim 1, wherein the channel is comprised of material selected from the group consisting of polymers, metals, ceramics, composites, glasses, and combinations thereof.

19. A process for controlling pests, comprising:
fitting a channel around a protected area;
wherein the channel comprises an interior surface and an exterior surface, with powder disposed on the interior surface; and
sealing the channel to a third surface on which the channel is to installed.

20. A process for manufacturing a pest control device, comprising:
forming a channel with an interior surface and an exterior surface;
disposing powder on the interior surface;
disposing a seal on the exterior surface; and
configuring the seal to prevent pests from passing between the exterior surface and a third surface on which the channel is to installed.
